(19) United States
(12) Patent Application Publication
(10) Pub. No.: US 2006/0155812 A1
(43) Pub. Date: Jul. 13, 2006

(54) Management of network devices via email

(76) Inventor: Jeffrey M. Looman, Provo, UT (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/303,869

(22) Filed: Dec. 15, 2005

Related U.S. Application Data
(60) Provisional application No. 60/636,717, filed on Dec. 15, 2004.

(51) Int. Cl. G06F 15/16

(52) U.S. Cl. 709/206

(57) ABSTRACT

A system and method for the management of networked devices via an email client. According to one embodiment, the present invention generally comprises three fundamental elements for managing a network: 1) an email client running on each of a plurality of network devices and at least one central email server hosting network device management accounts; 2) an email client plug-in for the purpose of using an email client as the management console for the network devices; and 3) an encrypted data encapsulation format used when information is transported between devices.

### CROSS-REFERENCE TO RELATED APPLICATION

The present application claims priority from U.S. Provisional Application Ser. No. 60/636,717 filed Dec. 15, 2004, which is incorporated herein by reference in its entirety for all purposes.

### BACKGROUND

1. Field of the Invention

The present invention relates to managing and coordinating the operation of a computer network. More specifically, the present invention relates to a system and method for using an email client application as an interface for managing and coordinating various devices within a network.

2. State of the Art

As known in the art, a computer network generally comprises a system of separate devices linked for communication with one another to allow functions such as coordinated execution of software applications or remote access of data. Computer networks may be configured from devices residing at a single location in the form of local area network (LAN) or at different geographical locations in the form of a wide area network (WAN), and may include physical or wireless communication channels. Nonlimiting examples of common devices making up a network may include application servers, such as directory servers, email servers and email caching devices, network management devices, such as switches and routers, as well as end user workstations. A network may also include further devices comprising voice, video and computing infrastructure (VVCI), such as those used to implement voice over internet services (VOIP), cellular or other wireless carrier services, cable services, etc.

In order to make an organization's network run properly, these devices must be configured to communicate and work in coordination with one another. This task is made more difficult, however, due to the fact that different classes of network devices are usually intended to perform distinct dedicated roles and are often provided by different vendors. As such, management of these devices may require that network device administrators use a variety of tools, usually proprietary, to manage each class of device. Maintaining consistent configurations across a large number of network devices therefore becomes difficult and, if not managed properly, could lead to failure of some or all of the network system.

Centralizing the management of network devices with a consistent interface would make network device administration more efficient and overcome the above-described problems associated with the prior art. The use of an email client would serve such a function. As used herein, an “email client” refers to a software application, component, or module that is capable of sending and receiving email over a network connection.

Most modern email clients provide the ability to manage data types beyond that of just simple text messages. They may include, for example, calendaring functions, management of tasks, notes, and journals, as well as the ability to transmit email messages with encoded content. Further, most email clients allow third party vendors to install plug-ins (e.g., accessory programs or code that provide additional functionality) that enhance the message management capabilities. The combination of these two integral elements of email clients would allow a vendor to develop a plug-in that uses email messages as a communication method to manage devices that are themselves running special purpose email clients within a network.

### SUMMARY

In accordance with a preferred embodiment of the present invention, a computer network is disclosed wherein each network device is provided with an embedded email client that serves as a proxy for the device itself. At least one of the network devices is configured to function as a network management station that, via communication with one or more conventional central email servers hosting network device management accounts, is used by a network device administrator to generate messages containing configuration information and/or queries sent to mailboxes corresponding to each device on the network. Network devices receiving the email messages respond according to the instructions embodied within the message such as by executing commands or answering queries via a “reply” message to the sender (e.g., the network device administrator at a network management station overseeing the network device management accounts). Network devices may also have the ability to originate messages, and send them to the network device management account(s) on a central email server.

Other and further features and advantages of the present invention will be apparent from the following descriptions of the various embodiments when read in conjunction with the accompanying drawing. It will be understood by one of ordinary skill in the art that the following embodiments are provided for illustrative and exemplary purposes only, and that numerous combinations of the elements of the various embodiments of the present invention are possible.

### BRIEF DESCRIPTION OF THE DRAWINGS

In the drawings, which illustrate an example of what is currently considered to be the best mode for carrying out the invention:

FIG. 1 is a schematic representation of an exemplary network according to the present invention.

### DETAILED DESCRIPTION OF PREFERRED EMBODIMENTS OF THE INVENTION

Referring in general to the accompanying drawing, various aspects of an exemplary computer network 2 are shown according to the present invention. Common elements of the disclosed embodiments are designated with like reference numerals for clarity. It should be understood that the figure presented is not meant to be illustrative of an actual configuration for a computer network, but is merely an idealized schematic representation employed to more clearly and fully depict the invention.

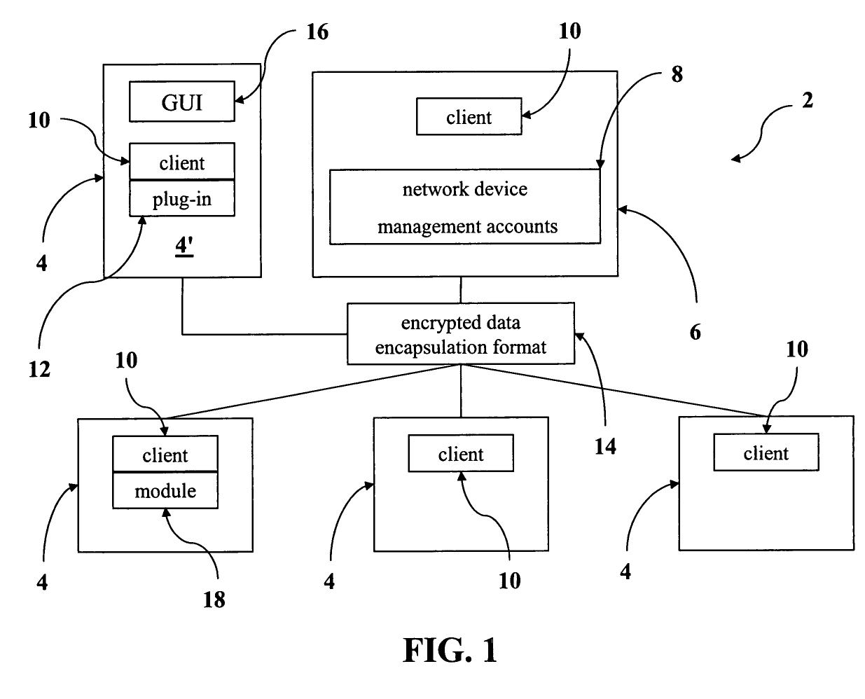

Turning to FIG. 1, network 2 is illustrated as including a plurality of network devices 4 (at least one of which is configured to function as a network management station 4′) and a central email server 6 for hosting network device management accounts 8. It should be understood that the number and configuration of devices shown in FIG. 1 is only exemplary, and that network 2 may include further devices and/or VVCI, depending on the specific implementation.

The preferred system and method according to the present embodiment generally comprises the implementation of three main elements for managing network 2: 1) an email client 10 running on each of the plurality of network devices 4 as well as on central email server 6; 2) an email client plug-in 12 written for the express purpose of using the email clients 10 as a management console for the network devices 4; and 3) an encrypted data encapsulation format 14 used when information is transported between devices. Each of these elements is discussed in further detail below according to exemplary embodiments of the present invention. While FIG. 1 depicts network 2 as using a single central email server 6 to host network management accounts 8, it is also possible that multiple email servers could be used, such as when different groups of network devices 4 are associated with different email servers. It is also within the scope of the present invention that network management accounts 8 might be stored on a server type other than central email server 6, and then accessed by central email server 6 as needed. Furthermore, network management station 4′ may be located on central email server 6, rather than on a separate network device.

According to the first element of the preferred embodiment, each participating network device 4 is provided with and configured to run an email client 10 such that it acts as a proxy for the device itself. Examples of email client software suitable for this purpose may include widely available open-source embedded email client software, commercial products such as Microsoft Outlook®, or even an email client comprising custom-made software, so long as it is capable of providing the desired functionality. Network devices 4 may be provided with a “headless” email client version (i.e., a client not requiring a direct user interface), while the email client version on a network device acting as a network management station 4′ includes a user interface such as graphical user interface (“GUI”) 16 for use by the network device administrator. An email client on a network device other than a network management station may also include a GUI, such as in situations where it is desirable to allow viewing of network data without management capabilities. It is also contemplated that each email client 10 may be comprised of different types or versions of software on each of network devices 4 and central email server 6, depending on the function, type and source of the specific hardware and software implemented. A network device running on a UNIX based operating system, for example, may require a different type of email client software than one running on a Microsoft Windows® based operating system.

Initial configuration of email client 10 may be embodied within a local file including information such as email server address, account name, account password, and initial encryption/decryption credentials. FIG. 1 shows that an additional executable software module 18 may be included on a network device 4 and associated with email client 10 to parse and execute instructions embedded within the body of a message, such as by using a remote procedure call method such as a simple object access protocol (“SOAP”) for information wrapped in extensible markup language (“XML”). Software module 18 may comprise a plug-in written for email client 10, or may be part of a stand-alone application that works in conjunction with email client 10. While the present embodiment is described in terms of instructions being embedded in the body of a message, it is also contemplated that instructions could be embedded in, and parsed from, other portions of an email, such as metadata or files attached to the email.

Each email client 10 outfitted to operate as a management console on a network management station 4′ is configured to install and run a plug-in 12 that does additional processing on email messages addressed to, and received from, network devices 4. The additional processing may include display of console panels within the confines of the email client GUI 16 presentation space, acquiring network device administrators' configuration settings and instructions, and encapsulating this information within an encrypted file and sending it to addressed network devices 4. Upon receiving email containing the encrypted information, a network device 4 may decrypt it using the additional software module 18 and subsequently apply the settings and instructions. For time-specific operations, each network device may interpret instructions based on its own time zone, while network administrators may deal in one time zone. Plug-in 12 may also be responsible for processing messages received from various network devices 4, decrypting the contents thereof and displaying the contents in the GUI 16 at the network management station 4′.

The final element of the system according to the present embodiment is the encrypted file format 14 such as encrypted XML. The encrypted file format may be necessary to prevent non-administrators from successfully sending unauthorized, inappropriate or erroneous commands to network devices 4, and to prevent such commands from being accepted by network devices 4.

Using the preferred embodiment, several conventional features built into modern email clients can be mapped directly to network device management operations, examples of which are as follows:
1. A mail group defined by an email client 10 on a network management station 4′ may represent a class of network devices 4 allowing any number of devices to receive the same set of configuration data at roughly the same time.
2. Configuration settings may be sent as emails and be stored in a common location such as in a “sent items folder” for subsequent tracking of configuration history. All previous configuration settings may also be sorted by date of execution.
3. Alerts regarding the status of specific network devices 4 may be sent as email messages with specific subject lines (e.g., “toner cartridge low”) and may allow priorities to be set to urgent.
4. Daily log files of network device operations may be generated and sent as messages, with the log file information included as an attachment.
5. Scheduled operations may be configured to appear as calendar items within GUI 16.
6. Tasking functions (for example, as provided by the Microsoft Outlook® “Tasks” function) may be used to represent maintenance items sent from each network device 4 that need to be completed. Thus, task items sent in emails can be sent by each network device 4 and managed at an email client 10 on one or more network management stations 4′ to reflect a set of outstanding maintenance items that need to be completed for each network device 4. One example task might be created when a printer under this system reports that its toner cartridge is low, thus generating an email with the task: ‘replace toner cartridge in xxx printer’ that is then sent on to a network management account 8 on central email server 6 for the attention of a network administrator.
7. Custom forms may be used to represent configuration console panels in GUI 16 allowing network device administrators to enter settings to control network device behavior.
8. Custom forms may also be used in GUI 16 to allow network device administrators to request information from network devices 4.
9. Journaling functions may be used to track and display interaction of all network administrators with a given network device 4.
10. Voting (e.g., a built-in voting system as is provided by Microsoft Outlook®) may be used to determine the state of a set of network devices 4, which may provide information on overall network performance.

In addition to the features of email clients 10 listed above, modern email servers host features that can be used to manage network devices 4 automatically. Many email servers, for example, host a rules engine that reacts to the content of a given message and uses macros to automatically execute actions on behalf of a network administrator. Central email server 6 may, for example, automatically reply with an email containing a reboot command upon receipt of an error state email sent by a network device 4. In addition, a second email could be sent to the network administrator, or a network health monitoring system, indicating execution of an automatic action. Under this type of configuration, central email server 6 could act as a bridge between disjoint systems separated by security measures.

Although the present invention has been depicted and described with respect to the illustrated embodiments, various additions, deletions and modifications are possible. Rather than using the above-described encrypted file format in network management, for example, prevention of unauthorized access or transmissions might be accomplished by using alternative features such as user IDs and/or passwords. It should also be understood that features from different embodiments may be employed in combination with one another, without departing from the spirit and scope of the present invention. The scope of the invention is, therefore, indicated by the appended claims rather than the foregoing description. All changes which come within the meaning and range of equivalency of the claims are to be embraced within their scope.

What is claimed is:

1. A computer network system, comprising:
at least one central email server;
at least one network management station in communication with the at least one central email server over a first network connection;
at least one network device in communication with the at least one email server over a second network connection;
software comprising an email client installed on the at least one central email server, the at least one network management station and the at least one network device; and
software associated with the email client installed on the at least one network management station to allow the email client to be used as a management console for the at least one network device.

2. The computer network system according to claim 1, further comprising an encrypted file format for encryption of emails sent over the first and second network connections for managing the at least one network device.

3. The computer network system according to claim 2, wherein the encrypted file format comprises encrypted XML.

4. The computer network system according to claim 1, wherein the email client software installed on the at least one network device is configured to reply to email queries from the at least one network management station.

5. The computer network system according to claim 1, wherein the email client software installed on the at least one network device is configured to originate messages including device information for transmission to a network device management account.

6. The computer network system according to claim 1, wherein the email client software installed on the at least one network device comprises a headless email client.

7. The computer network system according to claim 1, wherein the software associated with the email client software installed on the at least one network management station comprises a plug-in for the email client.

8. The computer network system according to claim 1, wherein the network management station is located on the central email server.

9. The computer network system according to claim 1, wherein information for managing the at least one network device is embedded in the body of emails sent over the first and second network connections.

10. The computer network system according to claim 1, wherein a mail group defined by the email client software installed on the at least one network management station represents a class of network devices.

11. The computer network system according to claim 1, wherein the email client software installed on the at least one network management station is configured to display scheduled management operations as calendar items.

12. The computer network system according to claim 1, wherein the email client software installed on the at least one network management station includes a GUI with custom forms for managing network devices.

13. A method of managing a computer network, comprising:
providing at least one central email server;
providing at least one network management station;
providing at least one network device;
transmitting an email from the at least one central email server to the at least one network device using an email client; and
managing a status of the at least one network device based on information contained within the email.

14. The method according to claim 13, wherein the email is transmitted in an encrypted file format.

15. The method according to claim 14, wherein the encrypted file format is selected to comprise encrypted XML.

16. The method according to claim 13, further comprising using email client software installed on the at least one network device to reply to the email from the at least one central email server.

17. The method according to claim 13, further comprising transmitting an email originating from the at least one network device to the at least one central email server.

18. The method according to claim 13, further comprising providing headless email client software on the at least one network device.

19. The method according to claim 13, wherein the email client comprises a plug-in for managing the at least one network device.

20. The method according to claim 13, further comprising providing the at least one network management station on the at least one central email server.

21. The method according to claim 13, further comprising embedding information for managing the at least one network device in the body of the email.

22. The method according to claim 13, further comprising defining a mail group with the email client that represents a class of network devices.

23. The method according to claim 13, further comprising displaying scheduled management operations as calendar items using the email client.

24. The method according to claim 13, further comprising providing a GUI with custom forms on the network management station for managing network devices.
